(19) United States
(12) Patent Application Publication
(10) Pub. No.: US 2008/0227943 A1
(43) Pub. Date: Sep. 18, 2008

(54) METHOD OF STORING COATING SOLUTION FOR FORMING INTERLAYER INSULATING FILM FOR SEMICONDUCTOR DEVICE

(75) Inventor: Hidetoshi HIRAOKA, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/046,487

(22) Filed: Mar. 12, 2008

(30) Foreign Application Priority Data
Mar. 15, 2007 (JP) 2007-066495

(51) Int. Cl. C08F 120/00

(52) U.S. Cl. 526/318.1

(57) ABSTRACT

A method of storing a coating solution for forming an interlayer insulating film for a semiconductor device, the method includes: storing a coating solution for forming an interlayer insulating film for a semiconductor device in a vessel having a wetted surface made of a plastic, and the coating solution containing at least one silane coupling agent.

### BACKGROUND OF THE INVENTION

1. Field of the Invention

The present invention relates to a method of storing a coating solution for forming an interlayer insulating film for semiconductor devices, more specifically, to an insulating material excellent in film properties such as dielectric constant, mechanical strength and adhesion properties and therefore used for electronic devices and the like, and a method of storing a coating solution containing a composition for forming the insulating material.

2. Description of the Related Art

In recent years, with the progress of high integration, multifunction and high performance in the field of electronic materials, circuit resistance and condenser capacity between interconnects have increased and have caused an increase in electric power consumption and delay time. Particularly, the increase in delay time becomes a large factor for reducing the signal speed of devices and generating crosstalk. Reduction of parasitic resistance and parasitic capacity are therefore required in order to reduce this delay time, thereby attaining speed-up of devices. As one of concrete measures for reducing this parasitic capacity, an attempt has been made to cover the periphery of an interconnect with a low dielectric interlayer insulating film. The interlayer insulating film is expected to have excellent heat resistance in a thin film formation step when a printed circuit board is manufactured or in post steps such as chip connection and pin attachment and also chemical resistance sufficient to withstand the wet process. In addition, a low resistance Cu interconnect has been introduced in recent years instead of an Al interconnect, and along with this, CMP (chemical mechanical polishing) has been employed commonly for planarization. Accordingly, an insulating film having mechanical strength great enough to withstand this CMP is required.

Highly heat-resistant interlayer insulating films such as polybenzoxazole, polyimide, polyarylene (ether) and the like have been disclosed for long years. Materials having a lower dielectric constant are demanded in order to realize a high speed device. Introduction of a hetero atom such as oxygen, nitrogen or sulfur or an aromatic hydrocarbon unit into the molecule of a polymer as in the above-described materials, however, increases a dielectric constant owing to high molar polarization, causes a time-dependent increase in the dielectric constant owing to moisture absorption, or causes a trouble impairing reliability of electronic devices so that these materials need improvement.

Compared with polymers composed of a hetero-atom-containing unit or aromatic hydrocarbon unit, polymers composed of a saturated hydrocarbon have a smaller molar polarization so that they have advantageously a lower dielectric constant. However, hydrocarbons such as polyethylene having high flexibility have insufficient heat resistance and therefore cannot be used for electronic devices.

Polymers having, in the molecule thereof, a saturated hydrocarbon having a rigid cage structure such as adamantane or diamantane are disclosed (Japanese Patent Laid-Open Nos. 2000-100808, 2001-2899 and 2001-2900). Adamantane or diamantane is a preferable unit because it has a diamondoid structure and exhibits high heat resistance and low dielectric constant. These polymers having such a unit are however accompanied with the drawbacks such as unsuitability for use in thin film formation because of a low solubility in a solvent and increase in a dielectric constant influenced by a linking group of the cage structure. These drawbacks must therefore be overcome.

Organic polymers on the other hand do not adhere well to silicon wafers and the like so that problems such as film peel tend to occur during interconnect processing. A solution obtained by dissolving an insulating film forming composition containing a polymer, which has been formed using an insulating material forming composition containing a compound having a cage structure (a polymer containing a cage structure), and an adhesion promoter in an organic solvent is therefore used as an insulating-film forming coating solution, but the coating solution containing a silane compound as the adhesion promoter has a short pot life.

### SUMMARY OF THE INVENTION

An object of the present invention is to overcome the above-described problems and, in order to form an insulating material having adequate mechanical strength, a low dielectric constant and excellent adhesion properties, provide a method of storing a coating solution for forming an interlayer insulating film for semiconductor devices capable of extending the pot life of the coating solution (the term “insulating film” is also referred to as “dielectric film” and “dielectric insulating film”, but these terms are not substantially distinguished). The coating solution is obtained by dissolving an insulating film forming composition containing a silane coupling agent in an organic solvent.

It has been found that the above-described problems can be overcome by the following constitutions.

(1) A method of storing a coating solution for forming an interlayer insulating film for a semiconductor device, the method comprising:

storing a coating solution for forming an interlayer insulating film for a semiconductor device in a vessel having a wetted surface made of a plastic, and the coating solution containing at least one silane coupling agent.

(2) The method as described in (1) above,

wherein the plastic is a material selected from the group consisting of polyethylene and a fluororesin.

(3) The method as described in (1) or (2) above,

wherein the at least one silane coupling agent contains at least one SiOH group in a structure thereof.

(4) The method as described in any of (1) to (3) above,

wherein the coating solution further contains a compound having a cage structure.

(5) The method as described in (4) above,

wherein the compound having a cage structure is a polymer of at least one compound represented by any of formulas (I) to (IV):

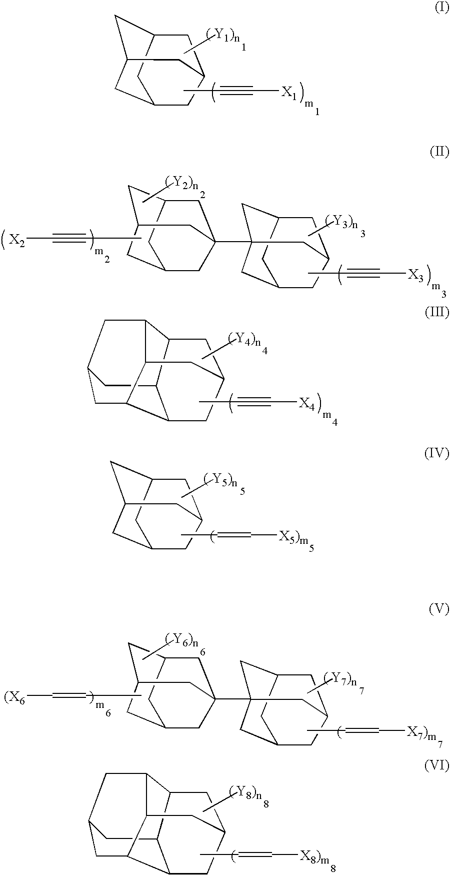

wherein X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group or a C₁₋₂₀ carbamoyl group;

Y₁(s) to Y₈(s) each independently represents a halogen atom, a C₁₋₁₀ alkyl group, a C₆₋₂₀ aryl group or a C₀₋₂₀ silyl group;

X₁(s) to X₈(s) and Y₁(s) to Y₈(s) each may be substituted by a substituent;

m₁ and m₅ each independently stands for an integer of from 1 to 16;

n₁ and n₅ each independently stands for an integer of from 0 to 15;

m₂, m₃, m₆ and m₇ each independently stands for an integer of from 1 to 15;

n₂, n₃, n6 and n₇ each independently stands for an integer of from 0 to 14;

m₄ and m₈ each independently stands for an integer of from 1 to 20; and

n₄ and n₈ each independently stands for an integer of from 0 to 19.

(6) The method as described in (5) above,

wherein the at least one compound is a compound represented by formula (III).

(7) The method as described in any of (1) to (6) above,

wherein the at least one silane coupling agent is selected from the group consisting of vinyltrimethoxysilane, vinyltriethoxysilane, vinyltriacetoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane.

### DETAILED DESCRIPTION OF THE INVENTION

The present invention will hereinafter be described specifically. In the method of storing a coating solution for forming an interlayer insulating film for semiconductor devices according to the invention, the pot life of the coating solution can be extended by storing the coating solution in a vessel having a wetted surface made of a plastic.

In the method of storing a coating solution for forming an interlayer insulating film for semiconductor devices according to the invention, a vessel having a wetted surface made of a plastic is used for storage. Examples of the plastic used for the wetted surface of the vessel include polyethylene, polypropylene, polystyrene, polyethylene terephthalate, polyvinyl chloride, ABS resins, FRP, polycarbonate, polymethylpentene, and fluororesins (PTFE and PFA). Glass vessels and metal vessels each coated with a fluororesin are also usable.

Of these, polyethylene and fluororesins are more preferred.

These vessels having a wetted surface made of a plastic extend the pot life of a coating solution for forming an insulating film which contains a silane coupling agent as an adhesion promoter and enable long-term storage presumably because of the following reason.

When a glass vessel is used for storage, a silane coupling agent is adsorbed to its wetted surface having an SiO structure and the silane coupling agent in the coating solution transfers to the wetted surface of the vessel during storage for long hours, causing a reduction in the concentration of the silane coupling agent in the coating solution. Such a phenomenon can be avoided when a plastic vessel is employed.

In the method of storing a coating solution for forming an interlayer insulating film for semiconductor devices according to the invention, a coating solution for forming an interlayer insulating film for semiconductor devices (which will hereinafter be called “coating solution” or “insulating material forming composition”, simply) stored in the vessel having a wetted surface made of a plastic contains a silane coupling agent.

The coating solution of the invention contains, in addition to the silane coupling agent, a polymer component.

A film containing a silane coupling agent and a polymer can be formed, for example, by applying the coating solution of the invention on a substrate and drying the resulting substrate. The substrate is then preferably heated.

Although no particular limitation is imposed on the silane coupling agent to be incorporated in the coating solution of the invention, usable are those available by hydrolysis or dehydration condensation of the following compounds: vinyltrimethoxysilane, vinyltriethoxysilane, vinyltriacetoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane.

For the coating solution of the invention, the above-described silane coupling agents may be used either singly or as a mixture of two or more thereof.

In the invention, the silane coupling agent is added in an amount of preferably from 0.001 to 15 wt %, more preferably from 0.005 to 8 wt %, especially preferably from 0.01 to 5 wt %, each based on 100 wt % of the polymer.

The coating solution of the invention preferably contains a compound having a cage structure.

The compound having a cage structure to be used in the invention will next be described specifically.

The compound having a cage structure may be a low molecular compound or a high molecular compound (for example, a polymer) insofar as it has a cage structure.

The term “cage structure” as used herein means a molecule whose space is defined by a plurality of rings formed by covalent-bonded atoms and a point existing within the space cannot depart from the space without passing through these rings. For example, an adamantane structure may be considered as the cage structure. On the other hand, a cyclic structure having a single crosslink, for example, norbornane(bicyclo[2,2,1]heptane) cannot be considered as the cage structure because the ring of the single-crosslinked cyclic compound does not define the space of the compound.

The cage structure may contain either a saturated bond or unsaturated bond. It may contain a hetero atom such as oxygen, nitrogen or sulfur atom, but the cage structure containing a saturated hydrocarbon is preferred from the viewpoint of a low dielectric constant.

Preferred examples of the cage structure include adamantane, biadamantane, diamantane, triamantane, tetramantane, and dodecahedrane, with adamantane, biadamantane and diamantane being more preferred. Biadamantane and diamantane are especially preferred because of a low dielectric constant.

The cage structure may have one or more substituents. Examples of the substituent include halogen atoms (fluorine, chlorine, bromine and iodine atoms), linear, branched or cyclic C₁₋₁₀ alkyl groups (such as methyl, t-butyl, cyclopentyl and cyclohexyl), C₂₋₁₀ alkenyl groups (such as vinyl and propenyl), C₂₋₁₀ alkynyl groups (such as ethynyl and phenylethynyl), C₆₋₂₀ aryl groups (such as phenyl, 1-naphthyl and 2-naphthyl), C₂₋₁₀ acyl groups (such as benzoyl), C₂₋₁₀ alkoxycarbonyl groups (such as methoxycarbonyl), C₁₋₁₀ carbamoyl groups (such as N,N-diethylcarbamoyl), C₆₋₂₀ aryloxy groups (such as phenoxy), C₆₋₂₀ arylsulfonyl groups (such as phenylsulfonyl), nitro group, cyano group, and silyl groups (such as triethoxysilyl, methyldiethoxysilyl and trivinylsilyl).

In the invention, the cage structure is preferably divalent, trivalent or tetravalent. In this case, a group to be coupled to the cage structure may be a monovalent or polyvalent substituent or a polyvalent linking group. The cage structure is preferably divalent or trivalent, especially preferably divalent.

The term “compound having a cage structure” as used herein means preferably a polymer of a monomer having a cage structure. The term “monomer” means a monomer which will be a dimer or polymer by polymerization. The polymer may be either a homopolymer or a copolymer.

The polymerization reaction of a monomer occurs by a polymerizable group substituted for the monomer. The term “polymerizable group” as used herein means a reactive substituent for causing polymerization of a monomer. No limitation is imposed on the polymerization reaction, but examples include radical polymerization, cationic polymerization, anionic polymerization, ring-opening polymerization, polycondensation, polyaddition, addition condensation and polymerization in the presence of a transition metal catalyst.

The polymerization reaction of a monomer is preferably performed in the presence of a nonmetallic polymerization initiator. For example, a monomer having a polymerizable carbon-carbon double bond or carbon-carbon triple bond can be polymerized in the presence of a polymerization initiator which generates a free radical such as carbon radical or oxygen radical by heating, thereby showing its activity.

As the polymerization initiator, organic peroxides and organic azo compounds are preferred, with organic peroxides being especially preferred.

Preferred examples of the organic peroxides include ketone peroxides such as “PERHEXA H”, peroxyketals such as “PERHEXA TMH”, hydroperoxides such as “PERBUTYL H-69”, dialkyl peroxides such as “PERCUMYL D”, “PERBUTYL C” and “PERBUTYL D”, diacyl peroxides such as “NYPER BW”, peroxyesters such as “PERBUTYL Z” and “PERBUTYL L”, and peroxydicarbonates such as “PEROYL TCP”, (each, trade name; commercially available from NOF Corporation).

Preferred examples of the organic azo compounds include azonitrile compounds such as “V-30”, “V-40”, “V-59”, “V-60”, “V-65” and “V-70”, azoamide compounds such as “VA-080”, “VA-085”, “VA-086”, “VF-096”, “VAm-110” and “VAm-111”, cyclic azoamidine compounds such as “VA-044” and “VA-061”, and azoamidine compounds such as “V-50” and VA-057” (each, trade name, commercially available from Wako Pure Chemical Industries).

These polymerization initiators may be used either singly or as a mixture of two or more of them.

The polymerization initiator is used in an amount of preferably from 0.001 to 2 moles, more preferably from 0.01 to 1 mole, especially preferably from 0.05 to 0.5 mole, per mole of the monomer.

It is preferred to carry out the polymerization of the monomer having a polymerizable carbon-carbon double bond or carbon-carbon triple bond, for example, in the presence of a Pd catalyst such as Pd(PPh₃)₄ or Pd(OAc)₂, a Ziegler-Natta catalyst, an Ni catalyst such as nickel acetyl acetonate, a W catalyst such as WCl₆, an Mo catalyst such as MoCl₅, a Ta catalyst such as TaCl₅, an Nb catalyst such as NbCl₅, an Rh catalyst or a Pt catalyst.

These transition metal catalysts may be used either singly or as a mixture of two or more thereof.

The amount of the transition metal catalyst is preferably from 0.001 to 2 moles, more preferably from 0.01 to 1 mole, especially preferably from 0.05 to 0.5 mole per mole of the monomer.

The cage structure in the invention may be substituted in a polymer main chain as a pendant group or may constitute a portion of the polymer main chain. The latter is preferred. When the cage structure constitutes a portion of the polymer main chain, the polymer chain is broken by the removal of the cage structure from the polymer. In this form, the cage structures may be singly bonded to each other directly or may be bonded via an appropriate divalent linking group. Example of the linking group include —C(R¹¹)(R¹²)—, —C(R¹³)═C(R¹⁴)—, —C≡C—, arylene group, —CO—, —O—, —SO₂—, —N(R¹⁵)—, and —Si(R¹⁶)(R¹⁷)—, and combinations thereof. In these groups, R¹¹ to R¹⁷ each independently represents a hydrogen atom or an alkyl, alkenyl, alkynyl, or aryl group. These linking groups may be substituted by a substituent and the above-described substituents are preferably employed here.

Of these, —C(R¹¹)(R¹²)—, —CH═CH—, —C≡C—, arylene group, —O— and —Si(R¹⁶)(R¹⁷)—, and combinations thereof are more preferred, with —C(R¹¹)(R¹²)— and —CH═CH— being especially preferred from the viewpoint of a low dielectric constant.

The compound having a cage structure in the invention may be either a low molecular compound or a high molecular compound (for example, a polymer), but a polymer is preferred. When the compound having a cage structure is a polymer, it has a mass average molecular weight of preferably from 1,000 to 500,000, more preferably from 5,000 to 200,000, especially preferably from 10,000 to 100,000. The polymer having a cage structure may be contained as a resin composition having a molecular weight distribution in an insulating film forming coating solution. When the compound having a cage structure is a low molecular compound, it has a molecular weight of preferably from 150 to 3,000, more preferably from 200 to 2,000, especially preferably from 220 to 1,000.

The compound having a cage structure is preferably a polymer of a monomer having a polymerizable carbon-carbon double bond or carbon-carbon triple bond. Moreover, it is preferably a polymer of a compound represented by the following formulas (I) to (IV).

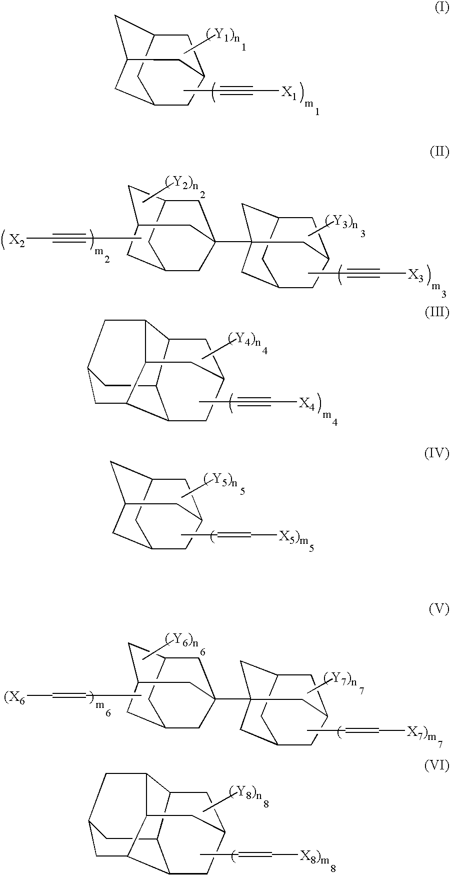

In the formulas (I) to (VI),

X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group, or a C₁₋₂₀ carbamoyl group, of which hydrogen atom, C₁₋₁₀ alkyl group, C₆₋₂₀ aryl group, C₀₋₂₀ silyl group, C₂₋₁₀ acyl group, C₂₋₁₀ alkoxycarbonyl group, or C₁₋₂₀ carbamoyl group is preferred; hydrogen atom or C₆₋₂₀ aryl group is more preferred; and hydrogen atom is especially preferred.

Y₁(s) to Y₈(s) each independently represents a halogen atom (fluorine, chlorine, bromine or the like), a C₁₋₁₀ alkyl group, a C₆₋₂₀ aryl group, or a C₀₋₂₀ silyl group, of which an optionally substituted C₁₋₁₀ alkyl group or C₆₋₂₀ aryl group is more preferred and an alkyl (methyl or the like) group is especially preferred.

X₁(s) to X₈(s) and Y₁(s) to Y₈(s) may each be substituted by another substituent.

In the above formulas,

m₁ and m₅ each independently stands for an integer from 1 to 16, preferably from 1 to 4, more preferably from 1 to 3, especially preferably 2;

n₁ and n₅ each independently stands for an integer from 0 to 15, preferably from 0 to 4, more preferably 0 or 1, especially preferably 0;

m₂, m₃, m₆ and m₇ each independently stands for an integer from 1 to 15, preferably from 1 to 4, more preferably 1 to 3, especially preferably 2;

n₂, n₃, n₆ and n₇ each independently stands for an integer from 0 to 14, preferably from 0 to 4, more preferably 0 or 1, especially preferably 0;

m₄ and m₈ each independently stands for an integer from 1 to 20, preferably from 1 to 4, more preferably from 1 to 3, especially preferably 2; and

n₄ and n₈ each independently stands for an integer from 0 to 19, preferably from 0 to 4, more preferably 0 or 1, especially preferably 0.

The monomer having a cage structure is preferably a compound represented by the above-described formula (II), (III), (V) or (VI), more preferably a compound represented by the formula (II) or (III), especially preferably a compound represented by the formula (III).

Two or more of the compounds having a cage structure may be used in combination, or two or more of the monomers having a cage structure according to the invention may be copolymerized.

The compound having a cage structure preferably has an adequate solubility in an organic solvent. The solubility is preferably 3 mass % or greater, more preferably 5 mass % or greater, especially preferably 10 mass % or greater in cyclohexanone or anisole at 25° C. (In this specification, mass ratio is equal to weight ratio.)

Examples of the compound having a cage structure include polybenzoxazoles described in Japanese Patent Laid-Open Nos. 1999-322929, 2003-12802, and 2004-18593, quinoline resins described in Japanese Patent Laid-Open No. 2001-2899, polyaryl resins described in International Patent Publication Nos. 2003-530464, 2004-535497, 2004-504424, 2004-504455, 2005-501131, 2005-516382, 2005-514479, and 2005-522528, Japanese Patent Laid-Open No. 2000-100808 and U.S. Pat. No. 6,509,415, polyadamantanes described in Japanese Patent Laid-Open Nos. 1999-214382, 2001-332542, 2003-252982, 2003-292878, 2004-2787, 2004-67877 and 2004-59444, and polyimides described in Japanese Patent Laid-Open Nos. 2003-252992 and 2004-26850.

Specific examples of the monomer having a cage structure and usable in the invention include, but are not limited to, the following ones.

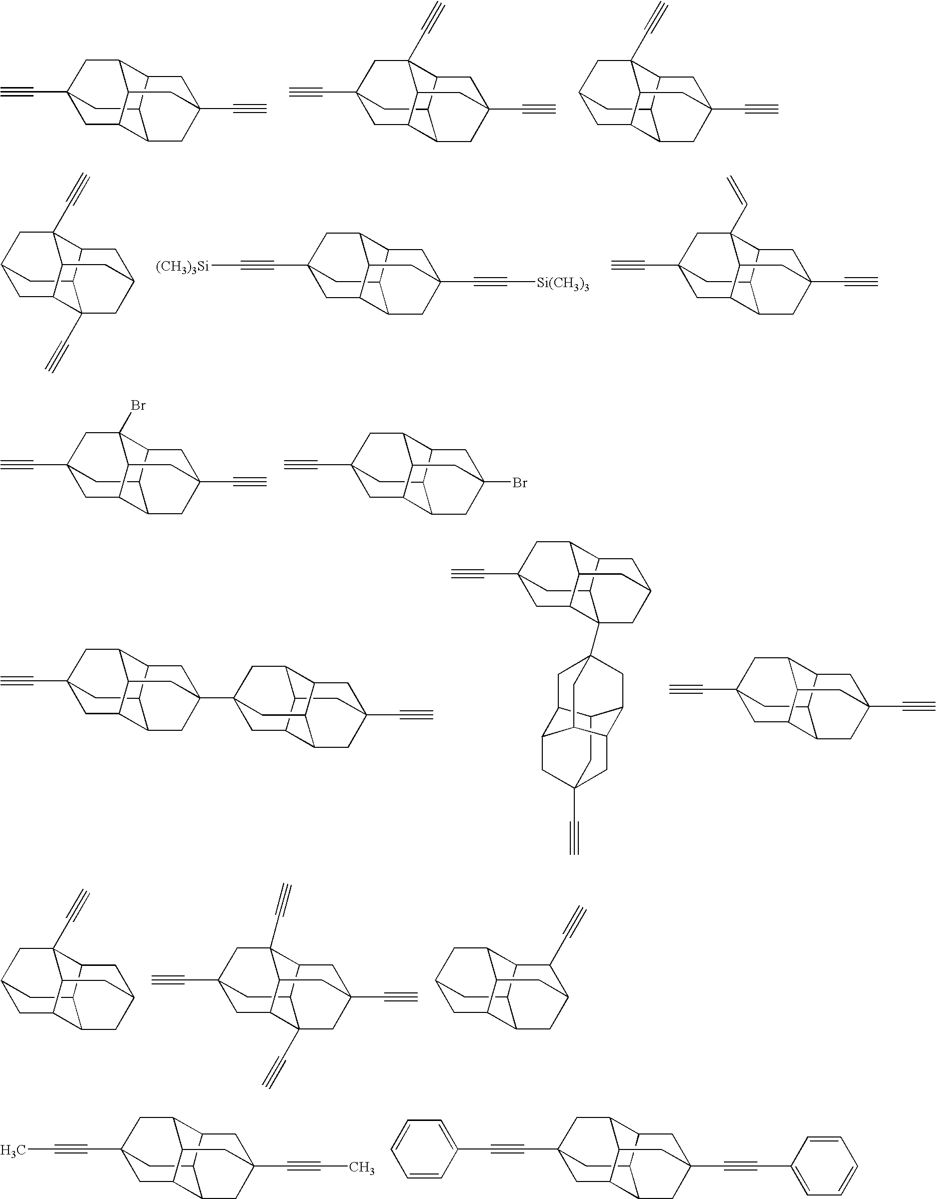

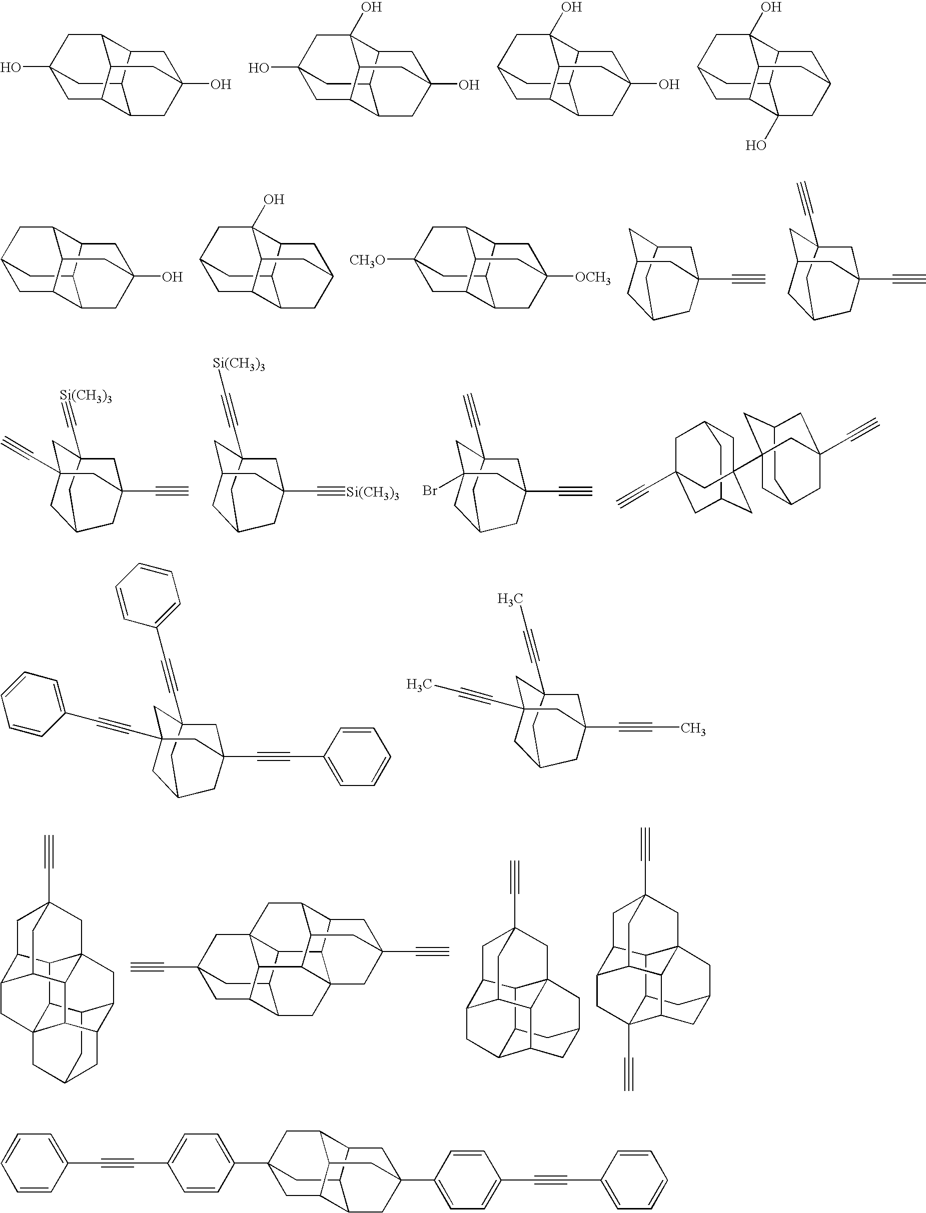

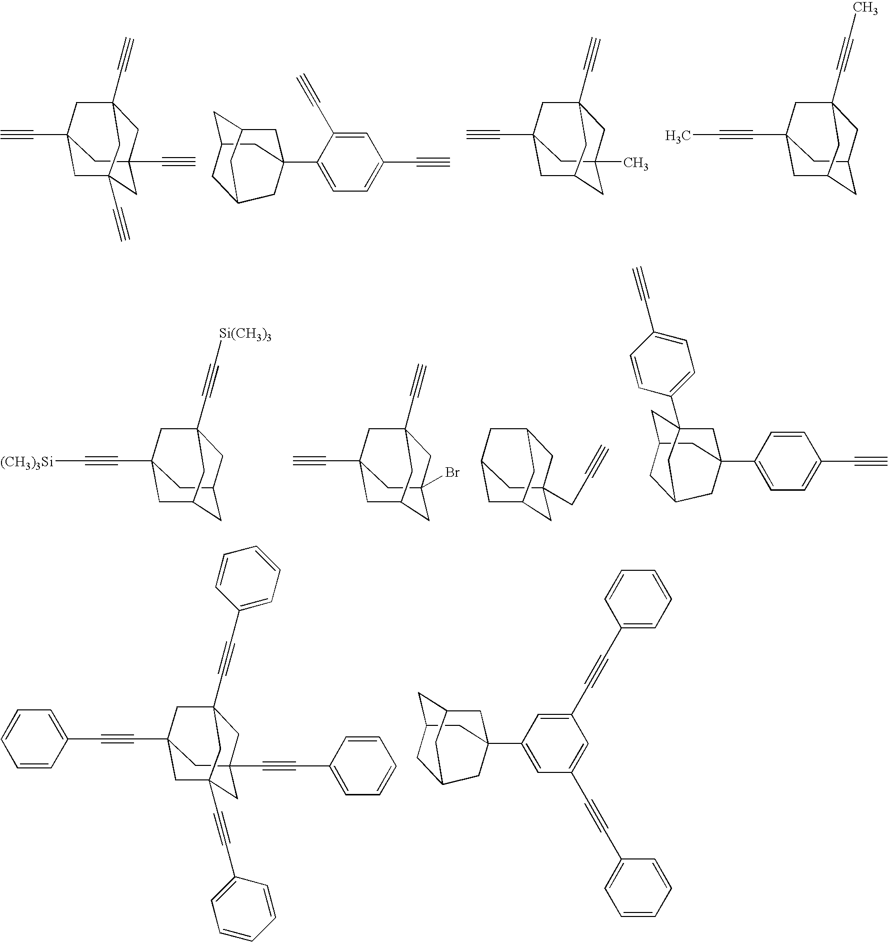

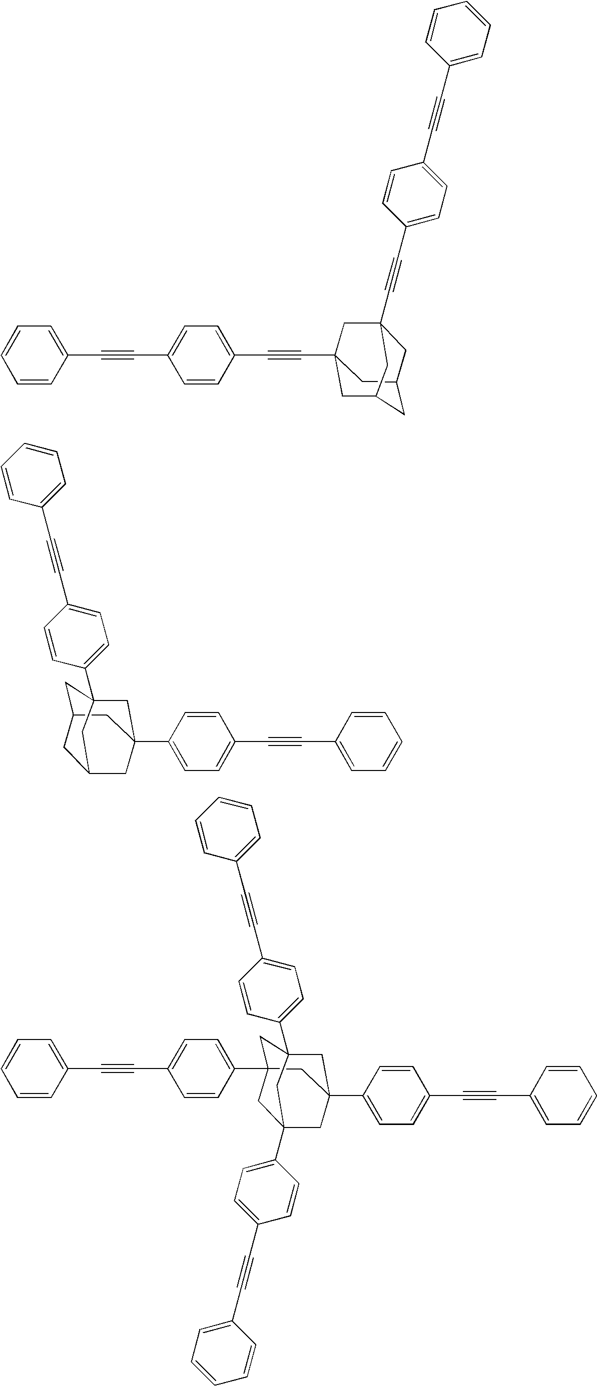

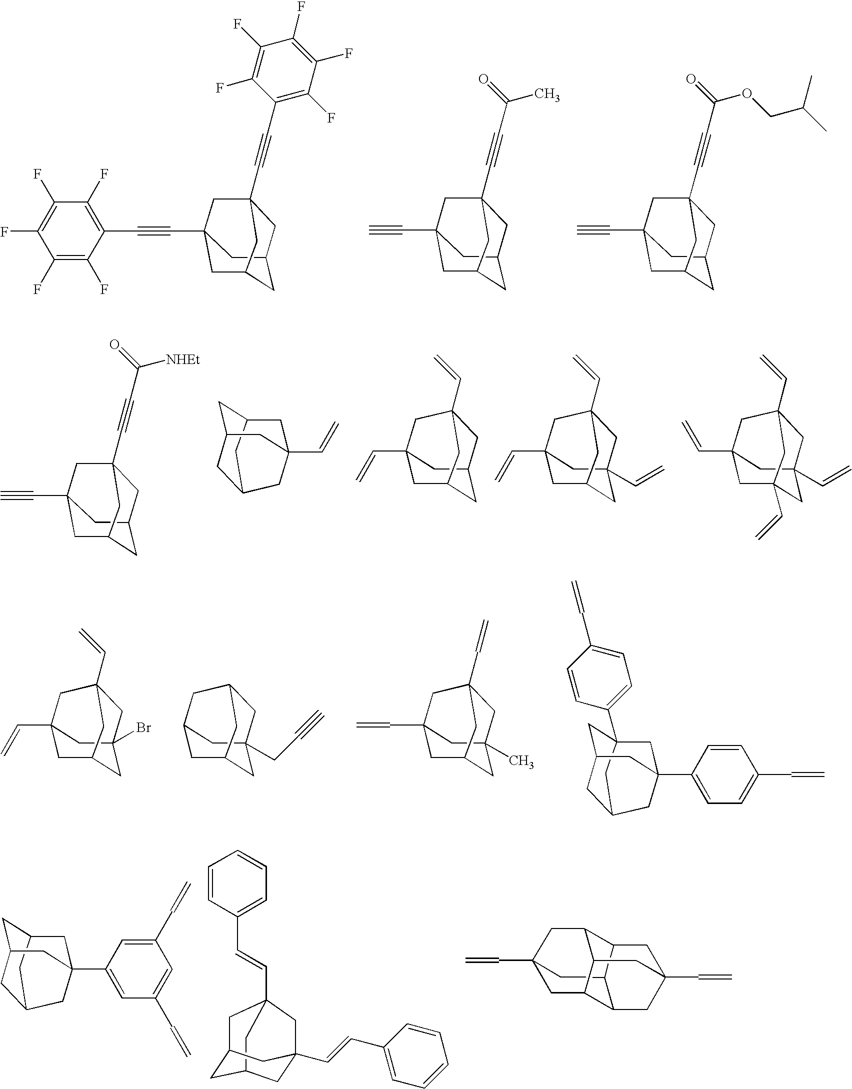

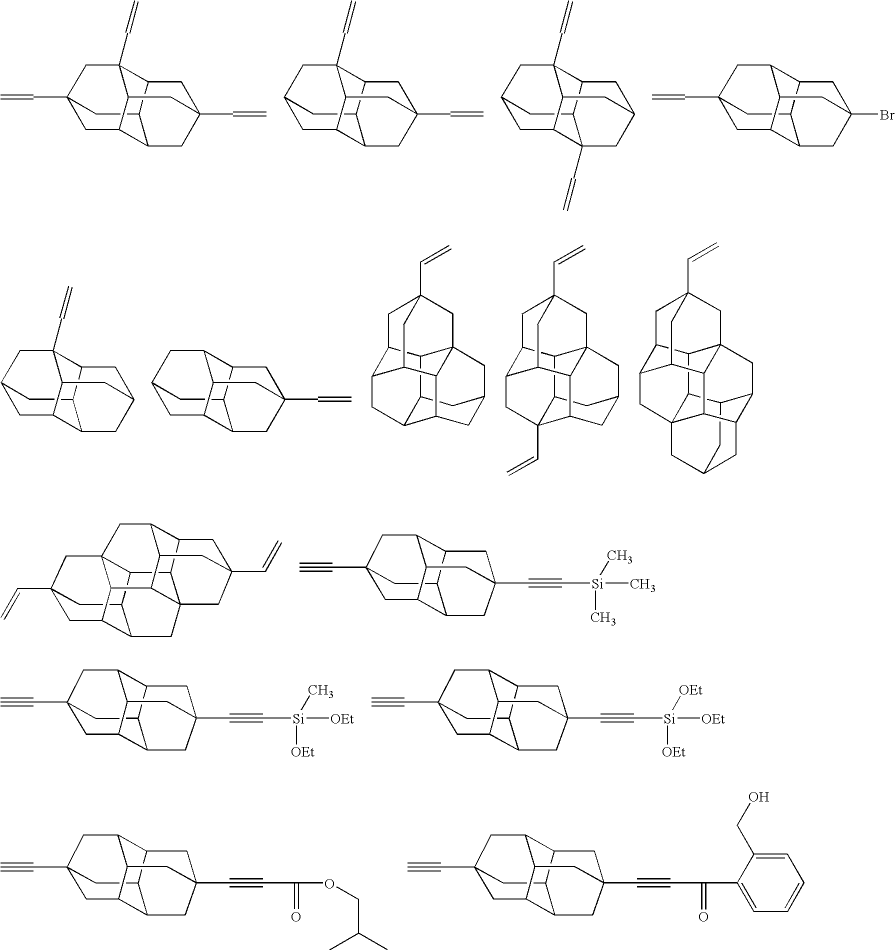

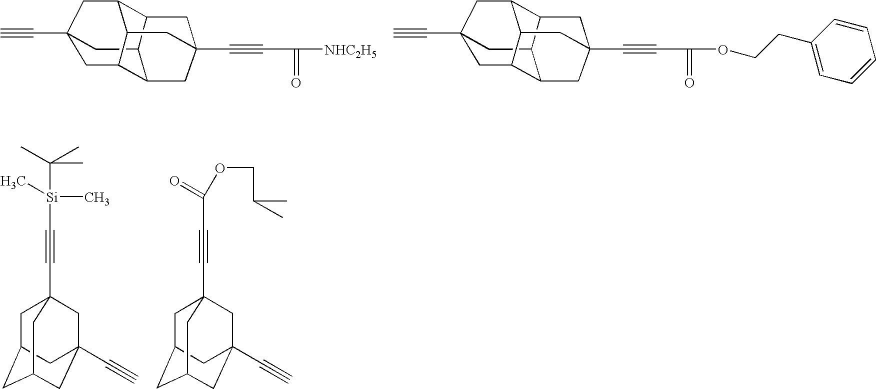

For the polymerization reaction, any solvent is usable insofar as it can dissolve the raw material monomer therein at a required concentration and does not adversely affect the properties of a film formed from the polymer thus obtained. Examples of the solvent include water; alcohol solvents such as methanol, ethanol and propanol; ketone solvents such as alcohol-acetone, methyl ethyl ketone, methyl isobutyl ketone, cyclohexanone and acetophenone; ester solvents such as ethyl acetate, butyl acetate, propylene glycol monomethyl ether acetate, γ-butyrolactone and methyl benzoate; ether solvents such as dibutyl ether and anisole; aromatic hydrocarbon solvents such as toluene, xylene, mesitylene, 1,2,4,5-tetramethylbenzene, pentamethylbenzene, isopropylbenzene, 1,4-diisopropylbenzene, t-butylbenzene, 1,4-di-t-butylbenzene, 1,3,5-triethylbenzene, 1,3,5-tri-t-butylbenzene, 4-t-butyl-orthoxylene, 1-methylnaphthalene and 1,3,5-triisopropylbenzene; amide solvents such as N-methylpyrrolidinone and dimethylacetamide; halogen solvents such as carbon tetrachloride, dichloromethane, chloroform, 1,2-dichloroethane, chlorobenzene, 1,2-dichlorobenzene and 1,2,4-trichlorobenzene; and aliphatic hydrocarbon solvents such as hexane, heptane, octane and cyclohexane. Of these solvents, preferred are acetone, methyl ethyl ketone, methyl isobutyl ketone, cyclohexanone, acetophenone, ethyl acetate, propylene glycol monomethyl ether acetate, 7-butyrolactone, anisole, tetrahydrofuran, toluene, xylene, mesitylene, 1,2,4,5-tetramethylbenzene, isopropylbenzene, t-butylbenzene, 1,4-di-t-butylbenzene, 1,3,5-tri-t-butylbenzene, 4-t-butyl-orthoxylene, 1-methylnaphthalene, 1,3,5-triisopropylbenzene, 1,2-dichloroethane, chlorobenzene, 1,2-dichlorobenzene, and 1,2,4-trichlorobenzene, of which tetrahydrofuran, 7-butyrolactone, anisole, toluene, xylene, mesitylene, isopropylbenzene, t-butylbenzene, 1,3,5-tri-t-butylbenzene, 1-methylnaphthalene, 1,3,5-triisopropylbenzene, 1,2-dichloroethane, chlorobenzene, 1,2-dichlorobenzene, and 1,2,4-trichlorobenzene are more preferred and γ-butyrolactone, anisole, mesitylene, t-butylbenzene, 1,3,5-triisopropylbenzene, 1,2-dichlorobenzene, and 1,2,4-trichlorobenzene are especially preferred. These solvents may be used either singly or as a mixture of two or more thereof.

The concentration of the monomer in the reaction mixture is preferably from 1 to 50 wt %, more preferably from 5 to 30 wt %, especially preferably from 10 to 20 wt %.

The optimum conditions of the polymerization reaction differ, depending on the kind, concentration or the like of the polymerization initiator, monomer or solvent. The polymerization reaction is effected at an internal temperature of preferably from 0 to 200° C., more preferably from 50 to 170° C., especially preferably from 100 to 150° C. for a polymerization time of preferably from 1 to 50 hours, more preferably from 2 to 20 hours, especially preferably from 3 to 10 hours.

The reaction is conducted preferably in an inert gas atmosphere (for example, nitrogen or argon) in order to suppress the inactivation of the polymerization initiator which will otherwise occur by oxygen. The oxygen concentration during the reaction is preferably 100 ppm or less, more preferably 50 ppm or less, especially preferably 20 ppm or less.

The polymer available by the polymerization has a mass average molecular weight of preferably from 1,000 to 500,000, more preferably from 5,000 to 300,000, especially preferably from 10,000 to 200,000.

The compound having a cage structure can be synthesized, for example, by using commercially available diamantane as a raw material, reacting it with bromine in the presence or absence of an aluminum bromide catalyst to introduce a bromine atom into the desired position of diamantane, causing a Friedel-Crafts reaction between the resulting compound with vinyl bromide in the presence of a Lewis acid such as aluminum bromide, aluminum chloride or iron chloride to introduce a 2,2-dibromoethyl group, and then converting it into an ethynyl group by the HBr elimination using a strong base. More specifically, it can be synthesized in accordance with the process described in Macromolecules, 24, 5266-5268 (1991) or 28, 5554-5560 (1995), Journal of Organic Chemistry, 39, 2995-3003 (1974) or the like.

An alkyl group or silyl group can be introduced by making the hydrogen atom of the terminal acetylene group anionic by butyllithium or the like and then reacting the resulting compound with an alkyl halide or silyl halide.

In the invention, the polymers having a cage structure may be used either singly or as a mixture of two or more thereof.

In the invention, the compound having a cage structure is preferably free of a nitrogen atom which will otherwise increase a molar polarization ratio or be a causative of hygroscopicity of an insulating material, because it has an action of increasing a dielectric constant. In particular, a polyimide compound cannot contribute to a sufficient reduction in dielectric constant so that the compound of the invention having a cage structure is preferably a compound other than a polyimide compound, that is, a compound having no imide bond.

In the invention, the compound having a cage structure is added in an amount of typically from 10 to 95 mass %, preferably from 30 to 90 mass % based on the total solids in the coating solution.

From the viewpoint of giving good properties (dielectric constant, mechanical strength) to the insulating film formed from the coating solution of the invention, a proportion of the total number of carbon atoms of the cage structure accounts for preferably 30% or greater, more preferably from 50 to 95%, still more preferably from 60 to 90% of the total number of carbon atoms of the total solids in the coating solution.

The term “total solids in the coating solution of the invention” as used herein means all the solids constituting the insulating film available from the coating solution. Solids which do not remain in the insulating film after formation thereof such as pore forming agent are not included in them.

The coating solution of the invention contains, in addition to the silane coupling agent and polymer component essentially contained therein, a solvent.

No particular limitation is imposed on the preferable solvent usable for the coating solution. Examples include organic solvents, e.g., alcohol solvents such as methanol, ethanol, isopropanol, 1-butanol, 2-ethoxymethanol, and 3-methoxypropanol; ketone solvents such as acetone, acetylacetone, methyl ethyl ketone, methyl isobutyl ketone, 2-pentanone, 3-pentanone, 2-heptanone, 3-heptanone, and cyclohexanone; ester solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether solvents such as diisopropyl ether, dibutyl ether, ethyl propyl ether, anisole, phenetole and veratrole; aromatic hydrocarbon solvents such as mesitylene, ethylbenzene, diethylbenzene, propylbenzene and 1,2-dichlorobenzene; and amide solvents such as N-methylpyrrolidinone and dimethylacetamide. These solvents may be used either singly or as a mixture.

Of these solvents, acetone, propanol, cyclohexanone, propylene glycol monomethyl ether acetate, methyl lactate, ethyl lactate, γ-butyrolactone, anisole, mesitylene, and 1,2-dichlorobenzene are more preferred.

The solid concentration of the coating solution of the invention is preferably from 3 to 50 mass %, more preferably from 5 to 35 mass %, especially preferably from 7 to 20 mass %.

Moreover, the coating solution of the invention may contain an additive such as radical generator, nonionic surfactant, or fluorinated nonionic surfactant without impairing various properties (heat resistance, dielectric constant, mechanical strength, coatability, adhesion properties and the like) of the insulating film formed by the coating solution.

Examples of the radical generator include t-butyl peroxide, pentyl peroxide, hexyl peroxide, lauroyl peroxide, benzoyl peroxide, and azobisisobutyronitrile; those of the nonionic surfactant include octylpolyethylene oxide, decylpolyethylene oxide, dodecylpolyethylene oxide, octylpolypropylene oxide, decylpolypropylene oxide, and dodecylpolypropylene oxide; those of the fluorinated nonionic surfactant include perfluorooctylpolyethylene oxide, perfluorodecylpolyethylene oxide, and perfluorododecylpolyethylene oxide.

The amount of these additives can be determined as needed, depending on the kind of the additives or solid concentration of the coating solution. The total amount of these additives in the coating solution is typically from 0.001 to 10 mass %, preferably from 0.01 to 5 mass %, more preferably from 0.05 to 2 mass %.

A porous insulating film (which will also be called “insulating material”) can also be formed by adding a pore forming agent to the insulating material forming composition of the invention. Although no particular limitation is imposed on the pore forming agent to be added to form the porous insulating material, examples include organic compounds having a boiling point higher than that of the solvent contained in the composition, thermally decomposable low molecular compounds and thermally decomposable polymers.

The amount of the pore forming agent can be selected as needed, depending on the solid concentration of the insulating film forming composition, but is typically from 0.01 to 20 mass %, preferably from 0.1 to 10 mass %, more preferably from 0.5 to 5 mass % in the insulating film forming composition.

The insulating film can be formed by applying the above-described coating solution of the invention onto a substrate by a desired method such as spin coating, roller coating, dip coating or scan coating, and then removing the solvent from the substrate by heat treatment. The heat treatment method is not particularly limited, but ordinarily employed methods such as hot plate heating, heating in a furnace, or heating in an RTP (Rapid Thermal Processor) to expose the substrate to light of, for example, a xenon lamp can be employed.

After application, the compounds having a cage structure are preferably crosslinked each other to obtain an insulating material excellent in mechanical strength and heat resistance. With regard to the optimum conditions of this heat treatment, the heating temperature is preferably from 200 to 450° C., more preferably from 300 to 420° C., especially preferably from 350 to 400° C., while heating time is preferably from 1 minute to 2 hours, more preferably from 10 minutes to 1.5 hours, especially preferably from 30 minutes to 1 hour. Heating treatment may be performed in several stages.

Although no particular limitation is imposed on the thickness of the insulating material, it is preferably from 0.001 to 100 μm, more preferably from 0.01 to 10 μm, especially preferably from 0.1 to 1 um.

The content of the silane coupling agent in the insulating material is typically from 0.05 to 5 mass %, preferably from 0.1 to 2 mass % based on the total solids.

Thus, an insulating film can be formed using the coating solution of the invention.

In order to obtain a film having better properties (dielectric constant, mechanical strength), a proportion of the total number of carbon atoms of the cage structure accounts for preferably 30% or greater, more preferably from 50 to 95%, still more preferably from 60 to 90% of the total number of carbon atoms constituting the insulating material.

The insulating material formed using the coating solution of the invention is suited for use as an insulating film in semiconductor devices and electronic parts such as multi-chip module multi-layered wiring board. It is usable as an interlayer insulating film, surface protective film or buffer coating film for semiconductor devices and also usable as a passivation film or a-ray shielding film for LSI, a coverlay film for flexographic printing plate, an overcoat film, a cover coating for a flexible copper-clad board, a solder resist film, and a liquid crystal alignment film.

### EXAMPLES

The present invention will hereinafter be described in further detail by Examples. It is needless to say that the scope of the invention is not limited by them.

### Example 1

In accordance with the synthesis process as described in Macromolecules, 5266 (1991), 4,9-diethynyldiamantane was synthesized. Under a nitrogen gas stream, polymerization was then performed by stirring 2 g of the resulting 4,9-diethynyldiamantane, 0.4 g of dicumyl peroxide (“PERCUMYL D”, trade name; product of NOF) and 10 ml of diphenylether for 5 hours at an internal temperature of 150° C. The reaction mixture was cooled to room temperature and then added to 100 ml of methanol. A solid thus precipitated was collected by filtration and washed with methanol, whereby 1.0 g of Polymer (A) having a mass average molecular weight of about 14,000 was obtained. Polymer (A) was found to have a solubility in cyclohexanone of 20 mass % or greater at 25° C.

Then, 1100 g of cyclohexanone and 5.81 g of ultrapure water were weighed. They were stirred at 25° C. and 25.0 g of vinyltriacetoxysilane (“Z6075”, product of Dow Corning Toray) was slowly added dropwise to yield Reaction mixture (A).

In a polyethylene vessel (“Clean Container”, product of AICELLO CHEMICAL), 6.00 g of cyclohexanone was dissolved completely in 3.00 g of a solution containing 1.00 g of Polymer (A) and Reaction mixture (A) to prepare a coating solution. The coating solution was stored for one week. The resulting coating solution was filtered through a 0.1 μm filter made of polytetrafluoroethylene, followed by spin coating on a silicon wafer. By heating at 200° C. for 60 seconds on a hot plate in a nitrogen gas stream and then baking for 60 minutes in a nitrogen-purged oven of 400° C., a 0.5 μm-thick uniform film free from seeding was obtained. A tape pull test was performed by drawing, on the film, 4×4 grids, each grid being 2 mm square. No peeling occurred. The relative dielectric constant of the film was calculated from the capacitance value at 1 MHz by using a mercury probe (product of Four Dimensions) and an LCR meter “HP4285A” (trade name; product of Yokogawa Hewlett-Packard), resulting in 2.40.

### Example 2

In a similar manner to Example 1 except for the use of “NOWPak” (trade name; product of ATMI Japan) instead of the polyethylene vessel, a coating solution was prepared. After storing for 1 week, a uniform 0.5 μm-thick film free of seeding was formed using the coating solution. As a result of carrying out a tape pull test while drawing 4×4 grids, each grid being 2 mm square, on the film, no peeling occurred. The relative dielectric constant of the film was calculated from the capacitance value at 1 MHz by using a mercury probe (product of Four Dimensions) and an LCR meter “HP4285A” (trade name; product of Yokogawa Hewlett-Packard), resulting in 2.41.

### Comparative Example 1

In a similar manner to Example 1 except for the use of a glass bottle instead of the polyethylene vessel, a coating solution was prepared. After storing for 1 week, a uniform 0.5 um-thick film free of seeding was formed using the coating solution. As a result of carrying out a tape pull test while drawing 4×4 grids, each grid being 2 mm square, on the film, the tape was peeled from all the grids. The relative dielectric constant of the film was calculated from the capacitance value at 1 MHz by using a mercury probe (product of Four Dimensions) and an LCR meter “HP4285A” (trade name; product of Yokogawa Hewlett-Packard), resulting in 2.41.

As is apparent from Examples 1 and 2 and Comparative Example 1, films excellent in properties such as surface uniformity, adhesion properties and dielectric constant were formed even after long-term storage in Examples relating to the method of storing a coating solution for forming an interlayer insulating film for semiconductor devices according to the invention, while the film formed in Comparative Example yielded unsatisfactory results.

The method of storing a coating solution for forming an interlayer insulating film for semiconductor devices according to the invention makes it possible to prolong the pot life of the coating solution containing a silane coupling agent as an adhesion promoter and form a film having good properties such as low dielectric constant and good adhesion properties even after long-term storage.

The entire disclosure of each and every foreign patent application from which the benefit of foreign priority has been claimed in the present application is incorporated herein by reference, as if fully set forth.

What is claimed is:

1. A method of storing a coating solution for forming an interlayer insulating film for a semiconductor device, the method comprising:
storing a coating solution for forming an interlayer insulating film for a semiconductor device in a vessel having a wetted surface made of a plastic, and the coating solution containing at least one silane coupling agent.

2. The method according to claim 1,
wherein the plastic is a material selected from the group consisting of polyethylene and a fluororesin.

3. The method according to claim 1,
wherein the at least one silane coupling agent contains at least one SiOH group in a structure thereof.

4. The method according to claim 1,
wherein the coating solution further contains a compound having a cage structure.

5. The method according to claim 4,
wherein the compound having a cage structure is a polymer of at least one compound represented by any of formulas (I) to (IV): 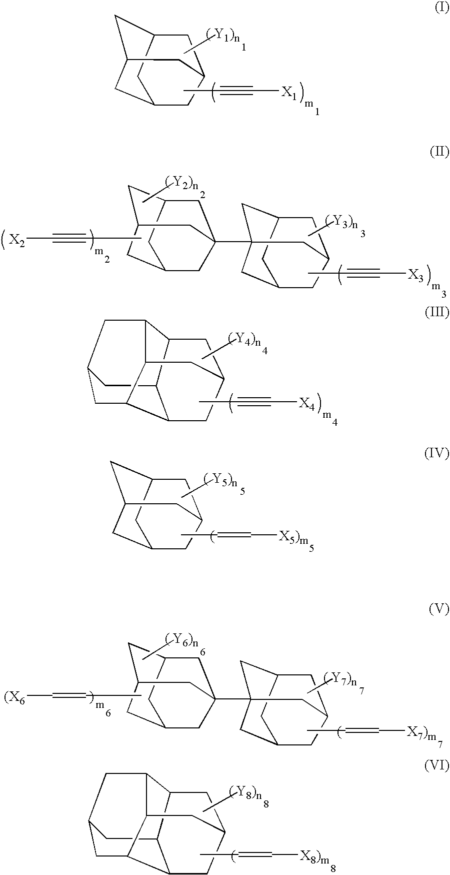
wherein X₁(s) to X₈(s) each independently represents a hydrogen atom, a C₁₋₁₀ alkyl group, a C₂₋₁₀ alkenyl group, a C₂₋₁₀ alkynyl group, a C₆₋₂₀ aryl group, a C₀₋₂₀ silyl group, a C₂₋₁₀ acyl group, a C₂₋₁₀ alkoxycarbonyl group or a C₁₋₂₀ carbamoyl group;
Y₁(s) to Y₈(s) each independently represents a halogen atom, a C₁₋₁₀ alkyl group, a C₆₋₂₀ aryl group or a C₀₋₂₀ silyl group;
X₁(s) to X₈(s) and Y₁(s) to Y₈(s) each may be substituted by a substituent;
m₁ and m₅ each independently stands for an integer of from 1 to 16;
n₁ and n₅ each independently stands for an integer of from 0 to 15;
m₂, m₃, m₆ and m₇ each independently stands for an integer of from 1 to 15;
n₂, n₃, n₆ and n₇ each independently stands for an integer of from 0 to 14;
m₄ and m₈ each independently stands for an integer of from 1 to 20; and
n₄ and n₈ each independently stands for an integer of from 0 to 19.

6. The method according to claim 5,
wherein the at least one compound is a compound represented by formula (III).

7. The method according to claim 1,
wherein the at least one silane coupling agent is selected from the group consisting of vinyltrimethoxysilane, vinyltriethoxysilane, vinyltriacetoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane and 3-acryloxypropyltrimethoxysilane.
